(19) United States
(12) Patent Application Publication
(10) Pub. No.: US 2025/0321338 A1
(43) Pub. Date: Oct. 16, 2025

(54) SYSTEM AND METHOD FOR NAVIGATION SYSTEM SPOOFING DETECTION USING DEEP LEARNING

(71) Applicant: NovAtel Inc., Calgary (CA)

(72) Inventors: Robert Hang, Calgary (CA); Ali Broumandan, Calgary (CA)

(21) Appl. No.: 18/637,186

(22) Filed: Apr. 16, 2024

(51) Int. Cl. G01S 19/21; G01S 19/45; G06N 3/02

(52) U.S. Cl. CPC G01S 19/215; G01S 19/45; G06N 3/02

(57) ABSTRACT

A system and method for a navigation system (NS) including global navigation satellite system (GNSS) spoofing detection using deep learning, such as a neural network, is provided. A GNSS signal is received by a receiver and one or more metrics are obtained from the received signal. Optionally, one or more non-GNSS signal metrics may also be obtained, e.g., information from an inertial measurement unit, vision system, independent time source, etc. The various metrics are fed into a trained neural network that decides as to whether spoofing is present and, if so, what is the type of spoofing that is occurring.

### BACKGROUND

Spoofing of signals from a global navigation satellite system (GNSS) is a well-known problem. During spoofing, an adverse actor provides a spoofing signal designed to cause a GNSS system to incorrectly determine its position, velocity, time, etc. As GNSS receivers are often used in applications that have safety of life (SOL) requirements, e.g., aviation, maritime, and land navigation, the incorrectly determined information may have catastrophic consequences. Similar spoofing may occur in other navigation systems (NS), such as a land-based navigation system. More generally, such spoofing may affect any NS that is capable of providing position, navigation, and time (PNT) information.

Typically, rule-based algorithms have been utilized to detect and classify spoofing attacks. After careful consideration of the various characteristics of a spoofer's feature, one or more rules may be created to detect the actions of a spoofer. A noted disadvantage is that it may be difficult to devise a suitable set of rules as spoofers may not have clear boundaries. Additionally, different spoofers may have features which are difficult to distinguish. A further disadvantage is that rules-based systems often have difficulty with certain types of cases, which may lead to inconsistent detection conditions. A final noted disadvantage is that new spoofing techniques may result in the need to modify rules to detect new spoofing techniques; however, these modified rules may cause rules for older known spoofing techniques to be less accurate.

### SUMMARY

The disadvantages of the prior art are overcome by the provided system and method for navigation system (NS) spoofing detection using deep learning, such as a neural network. In one exemplary embodiment, the NS is a global navigation satellite system (GNSS); however, in alternative embodiments other NS that generate PNT information may be utilized. In accordance with an illustrative embodiment of the present invention, a GNSS signal is received by a receiver and one or more metrics are obtained from the received signal. Optionally, one or more non-GNSS signal metrics may also be obtained, e.g., information from an inertial measurement unit, vision system, network time, barometers, etc. The various metrics are fed into a trained neural network that decides as to whether spoofing is present and, if so, what is the type of spoofing that is occurring.

In an alternative embodiment of the present invention, each of the various types of metrics that are obtained are fed into specialized neural networks that generate intermediate results. These intermediate results may then be provided as inputs to either a rules-based system, a second level neural network, or both to generate a final decision as to whether spoofing is present and, if so, what type of spoofing is occurring. Using such rules-based system combined with a second-level neural network also allows fail-safe operation whereby if the rules-based systems output disagrees with the neural network output, an ‘uncertain spoofing’ decision can be made and appropriate action can be taken by the user to operate in a fail-safe mode, e.g., request human intervention in the case of autonomous vehicles.

By use of embodiments disclosed herein, a GNSS receiver, or other GNSS system, may more accurately detect and classify the type of spoofing occurring. This enables the system to take appropriate remedial action based on the detected and classified type of spoofing attack that is occurring.

### BRIEF DESCRIPTION OF THE DRAWINGS

The above and further advantages of the present invention are described in connection with the accompanying drawings in which like reference numerals indicate identical or functionally equivalent elements:

FIG. 1 is a block diagram of an exemplary GNSS spoofing environment as implemented in an exemplary automobile in accordance with an illustrative embodiment of the invention;

FIG. 2 is a schematic block diagram of an exemplary GNSS receiver in accordance with an illustrative embodiment of the invention;

FIG. 3A is a graph illustrating a possible spoofing attack;

FIG. 3B is a graph illustrating a possible spoofing attack;

FIG. 3C is a graph illustrating a possible spoofing attack;

FIG. 3D is a graph illustrating a possible spoofing attack;

FIG. 4A is a graph illustrating an exemplary interference scenario in the time and frequency domains;

FIG. 4B is a graph illustrating an exemplary interference scenario in the time and frequency domains;

FIG. 4C is a graph illustrating an exemplary interference scenario in the time and frequency domains;

FIG. 4D is a graph illustrating an exemplary interference scenario in the time and frequency domains;

FIG. 4E is a graph illustrating an exemplary interference scenario in the time and frequency domains;

FIG. 4F is a graph illustrating an exemplary interference scenario in the time and frequency domains;

FIG. 5A is a power spectral density graph of authentic GNSS data;

FIG. 5B is a power spectral density graph of a wideband jammer at the L1 band;

FIG. 5C is a power spectral density graph of a spoofer at GPS L1 band and a jammer at GLO L1;

FIG. 6A is graph indicating the cross-ambiguity function of authentic GNSS data;

FIG. 6B is graph indicating the cross-ambiguity function of authentic GNSS data that includes a spoofer signal;

FIG. 6C is graph indicating the cross-ambiguity function of authentic GNSS data in the presence of a continuous wave (CW) jamming signal;

FIG. 7 is a schematic diagram of an exemplary neural network for spoofing detection in accordance with an illustrative embodiment of the invention;

FIG. 8 is a schematic diagram of an exemplary two stage system of spoofing detection in accordance with an illustrative embodiment of the invention;

FIG. 9 is a flowchart detailing the steps of a procedure for using a neural network for spoofing detection in accordance with an illustrative embodiment of the invention; and

FIG. 10 is a flowchart detailing the steps of a procedure for using a two-stage system for spoofing detection in accordance with an illustrative embodiment of the invention.

### DETAILED DESCRIPTION OF AN ILLUSTRATIVE EMBODIMENT

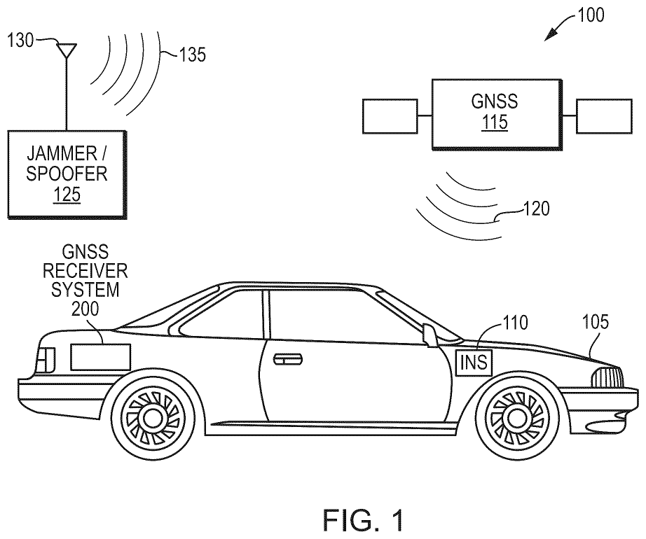

FIG. 1 is a block diagram of an exemplary GNSS spoofing environment 100 in accordance with an illustrative embodiment of the invention. Exemplary spoofing environment is shown as a land-based navigation environment. However, it should be noted that the principles of the present invention will operate in other environments, e.g., marine, aviation, pedestrian, etc. Therefore, the description of a land-based navigation environment should be taken as exemplary only. Further, while the description contained herein is of an exemplary GNSS embodiment, the principles of the present invention may be used for any NS implementation that may be spoofed. Therefore, the description of GNSS should be taken as exemplary only.

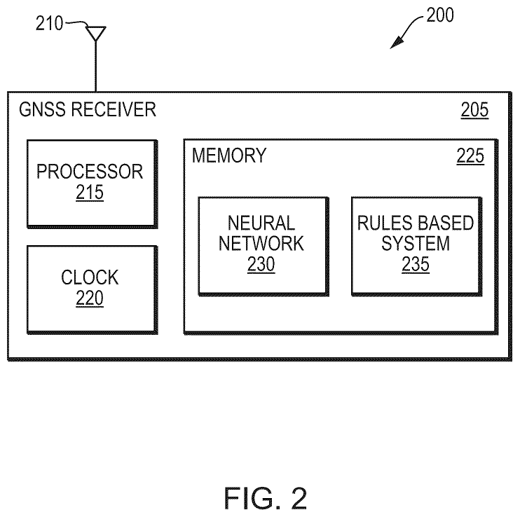

Environment 100 illustratively comprises of automobile 105 that includes a GNSS receiver system (receiver 205 and associated antenna 210) 200, described below in reference to FIG. 2. Optionally, the automobile 105 may include an inertial navigation system unit (INS) 110 for collection of inertial data for navigation purposes. In alternative embodiments, other sensors may be utilized, e.g., vision capture, etc. Therefore, the description of INS 110 should be taken as exemplary only. As will be appreciated by those skilled in the art, the INS 110 may comprise an inertial measurement unit (IMU) (not shown).

A global navigation satellite system (GNSS) satellite 115 broadcasts GNSS signals 120. As will be appreciated by those skilled in the art, while a single GNSS satellite 115 is shown, in operation, a plurality of satellites will be in operation. The number of satellites that are visible may be dependent on the location of vehicle 105 as well as the constellations of satellites that are being used, i.e., the particular GNSS system that is being used. Therefore, the description of a single satellite 115 should be taken as exemplary only.

A jammer/spoofer 125 broadcasts spoofing signals 135 via antenna 130. As will be appreciated by those skilled in the art, while a single spoofer 125 is shown and described, in alternative environments, a plurality of spoofers 125 may be acting at the same time. Therefore, the description of a single spoofer 125 should be taken as exemplary only. The spoofer 125 may utilize one or more types of spoofing signals 135, described further below. Further, in accordance with various environments, differing spoofers 125 may utilize differing types of spoofing signals 135 at the same time. The description of a single type of spoofing attack should be taken as exemplary only.

FIG. 2 is a schematic block diagram of an exemplary GNSS receiver system 200 in accordance with an illustrative embodiment of the invention. Exemplary receiver 205 is operatively interconnected with antenna 210 used for receiving GNSS signals. The receiver 200 illustratively comprises a processor 215, clock 220, and memory 225. Illustratively, GNSS receiver 205 is configured to receive GNSS signals 120 at antenna 210 and calculate navigation and location information, such as position, velocity, time, and attitude. As will be appreciated by those skilled in the art, such computations may be performed in software, hardware, firmware, or a combination thereof. The modules used for such GNSS calculations are not shown in exemplary FIG. 2.

Memory 225 illustratively stores software including, e.g., a neural network 230 and a rules-based system 235 for use in spoofing detection and characterization. As will be appreciated by those skilled in the art, additional and/or differing software may be stored in memory 225. In alternative embodiments of the present invention, these modules 230, 235 may be implemented in hardware, firmware, software, and/or a combination thereof. Therefore, the description of these modules 230, 235 being software should be taken as exemplary only.

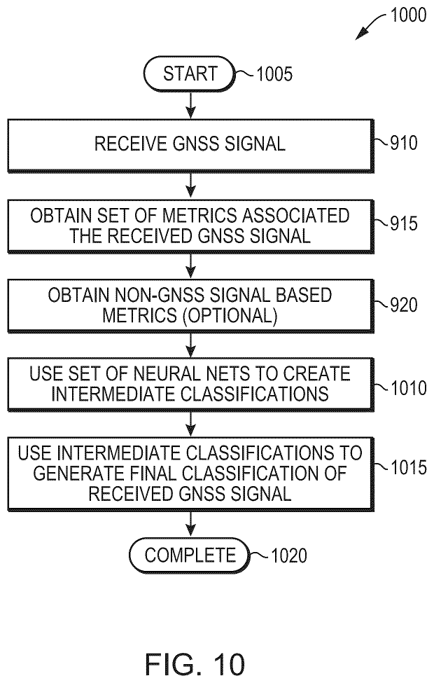

Processor 215 illustratively executes software to implement the functionality of the receiver 205. Clock 220 is utilized to provide a time basis for system 200. Neural network 230 illustratively implements the neural network functionality as described further below. In alternative embodiments, a plurality of neural networks 230 may be utilized. Therefore, the description of a single neural network should be taken as exemplary only. The rules-based system 235 may be utilized in alternative embodiments as a second stage in a two-stage spoofing detection embodiment, as described further below in reference to FIG. 10.

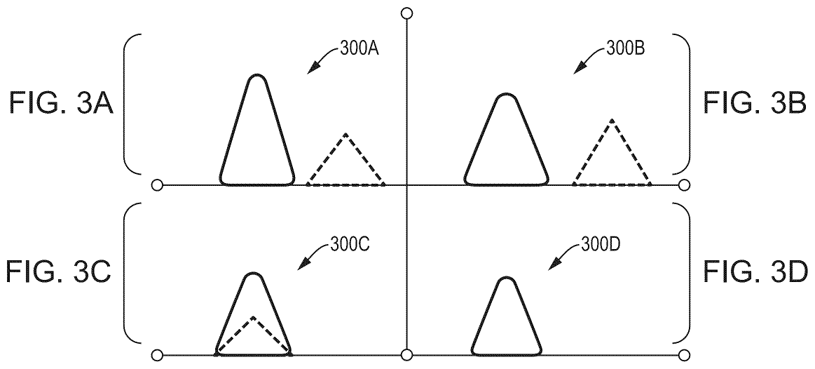

FIGS. 3A-D illustrate a plurality of types of spoofing attacks. In FIGS. 3A-D, authentic signal correlation functions are shown in dashed lines and spoofing signal correlation functions are shown in solid lines. The types of spoofing attacks described herein are for background purposes to allow a better understanding of neural network decisions as described further below in reference to illustrative embodiments of the present invention.

FIG. 3A shows a jamming/spoofing correlation function along with the authentic correlation function 300A. In this case, which is a high-power spoofing attack, the spoofer attempts to first jam a receiver which is tracking a GNSS signal and then spoof the target receiver. Illustratively, this can be done by masking the authentic signals by increasing the receiver noise floor and introducing the spoofing signals with a plausible carrier to noise ratio (C/N₀). Monitoring the antenna input power can be used to detect this type of attack. Depending on the spoofer's characteristics, the spoofing signals may be different from actual signals. This may allow some features of signals, such as the sharpness of the correlation peak, to be used to detect the attack.

FIG. 3B shows a matched power attack 300B where the spoofing power is within a few decibels (dBs) of the power level of the authentic signal. This type of attack is typically used in synchronized spoofing cases where the spoofer has knowledge of the receiver position and actual GNSS signals. This type of attack does not significantly increase the noise level, so power monitoring metrics typically cannot be used to detect it.

FIG. 3C shows a synchronized attack 300C where the correlation function of the authentic and spoofing signals overlap. The spoofing power is within the authentic signal's power range. Therefore, the attack does not significantly increase the total input power. This type of attack causes distortion on the correlation peak and can be detected by monitoring the correlation function shape or signal quality monitoring (SQM).

FIG. 3D shows an exemplary covered attack 300D. In this case, the spoofer masks the reception of the authentic signals by covering the target receiver antenna and injecting the spoofing signals. Detection of this type of attack is very difficult for a single antenna receiver.

In operation, a plurality of differing spoofing detection metrics may be utilized for a single antenna receiver. Each metric illustratively utilizes a specific feature of one or more of the types of attacks as described above in relation to FIGS. 3A-D.

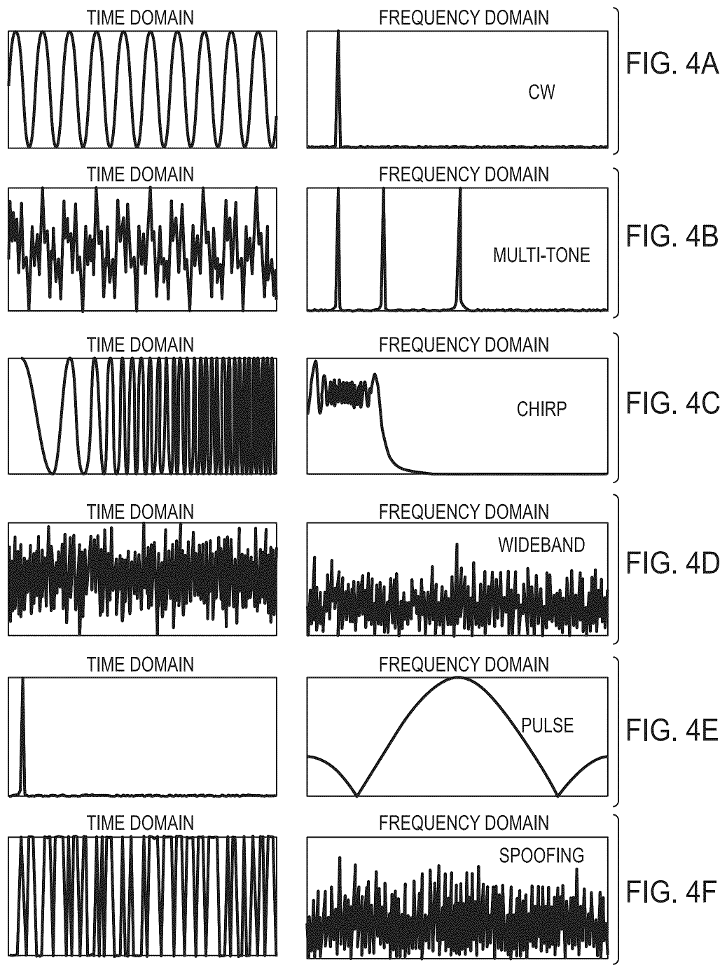

As shown above, a successful way to spoof a receiver is to jam and spoof it. Monitoring the input power is therefore an effective method to detect the attack. FIGS. 4A-F illustrate different interference scenarios in both the time and frequency domains. Spoofing is considered as a jamming source that misleads the position solution of the receiver. Illustratively, one objective is to distinguish between spoofing and other jamming attacks.

FIG. 4A illustrates a continuous wave (CW) jamming attack. FIG. 4B illustrates an exemplary multi-tone jamming signal. FIG. 4C illustrates a chirp jamming signal. FIG. 4D illustrates a wideband jamming signal. FIG. 4E illustrates a pulsed jamming signal. FIG. 4F illustrates an exemplary spoofing signal.

A GNSS receiver uses a Signal-to-Noise Ratio (SNR), which is then translated to Carrier-to-Noise Ratio (C/N₀), to measure the received signal strength. A spoofer typically attempts to impose its signal over the authentic signal to mislead the GNSS receiver. One illustrative approach to detect spoofing activities is to monitor the input power level. An exemplary detection method is to monitor both receiver noise level and the signal level entering the GNSS antenna. The total GNSS power near the Earth's surface is constant. As such, the total power received in the desired bandwidth should be constant and can be calibrated a priori. Additional power that is detected in-band can be monitored and reported as jamming or spoofing. Illustratively, this can be achieved by calibrating the noise floor and monitoring both noise and signal levels. In a jamming scenario, the noise floor will increase but the signal level should not change. This results in reduction of SNR measurements commensurate to the increased noise level. However, in a spoofing scenario, both signal and noise may increase. This results in an inconsistency between the increase in the noise power and the drop of SNR measurements.

For the absolute power monitoring method, the total input power entering the receiver is compared to the average C/N₀ measurements.

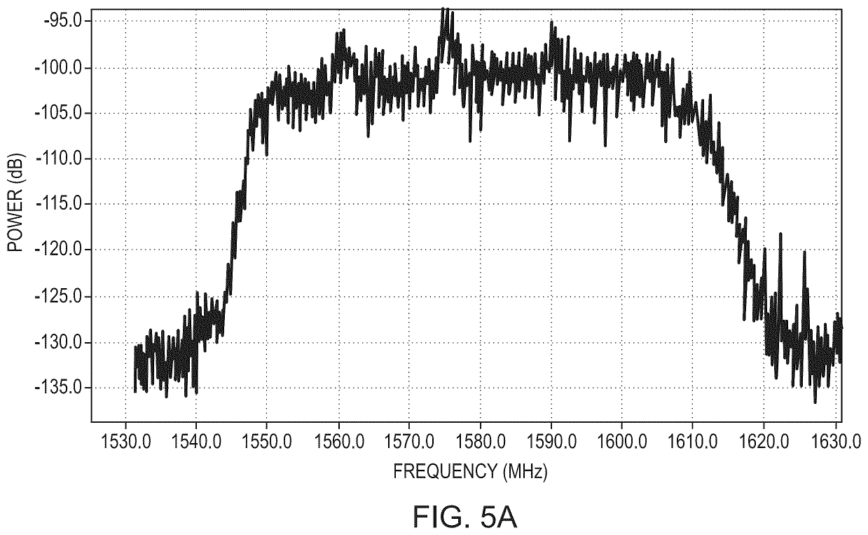

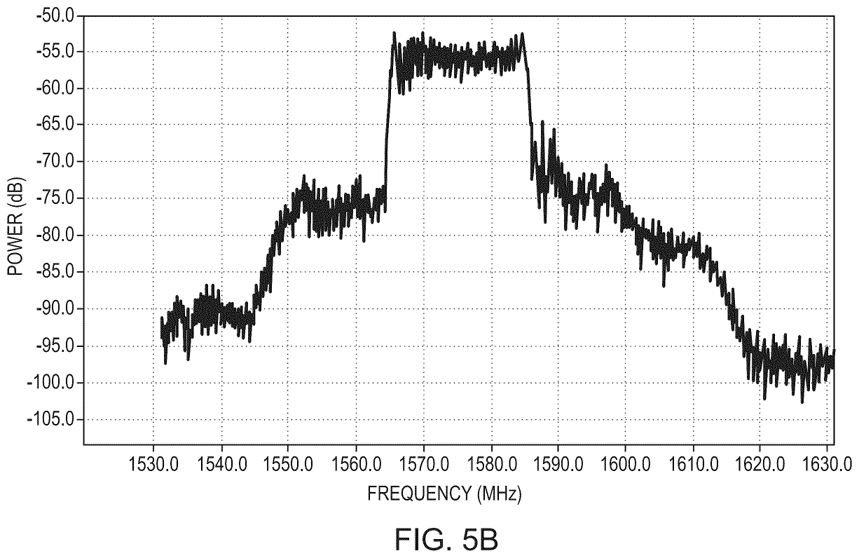

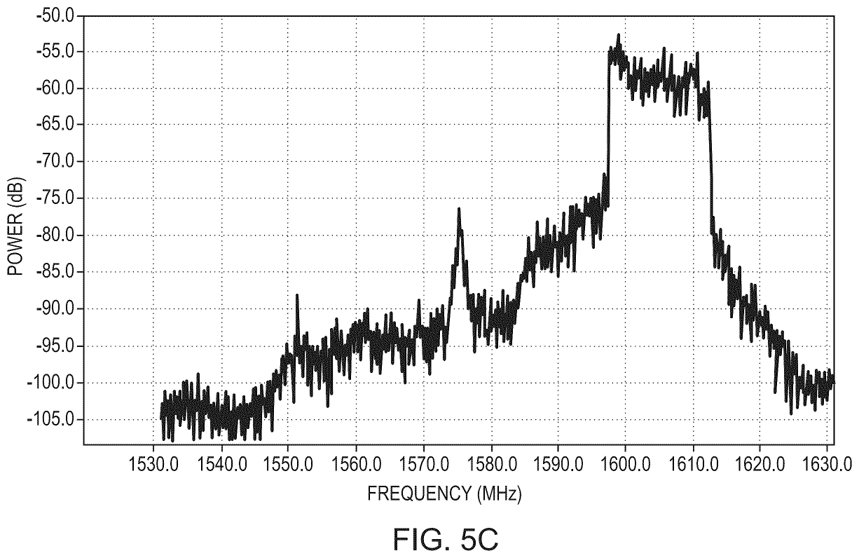

Power spectral density (PSD) is a metric to measure the signal power in the frequency domain. Monitoring the PSD under clean, jamming, and spoofing scenarios can be used for spoofing detection. Some examples of the use of monitoring PSD are described in U.S. patent application Ser. No. 18/440,108, entitled SYSTEM AND METHOD FOR NEURAL NETWORK AIDED INTERFERENCE ESTIMATION, filed on Feb. 13, 2024, and U.S. patent application Ser. No. 17/982,021, entitled GNSS-RECEIVER INTERFERENCE DETECTION USING DEEP LEARNING, filed Nov. 7, 2022. Examples of PSD under clean, jamming, and jamming/spoofing scenario are shown in FIG. 5A-5C.

FIG. 5A illustrates a PSD graph of authentic data. FIG. 5B illustrates a PSD graph of a wideband jammer operating at the L1 band. FIG. 5C illustrates a PSD graph of a spoofer operating in the GPS L1 band combined with a jammer operating in the GLO L1 band.

Illustratively, to decide as to whether spoofing is occurring or not and, if it is, what type of spoofing attack is occurring, a number of metrics may be analyzed. Illustratively, these metrics may be based on an analysis of a received GNSS signal. However, in alternative embodiments, metrics not based on a received GNSS signal may be utilized in spoofing determinations.

An exemplary first metric is effective C/N₀, which is a common signal monitoring metric available in most commercial receivers. Generally, three terms can affect the effective C/N₀. The first one corresponds to the noise component due to thermal noise or other interference sources, the second refers to the cross correlation between counterfeit signals and authentic replica and the third refers to the cross correlation caused by other authentic signals. The cross-correlation term caused by high power spoofing signals can become the dominant term which is directly proportional to the power level of spoofing signals. This term considerably reduces the effective C/N₀ of authentic PRNs (pseudorandom noise codes) and leads to saturation of spoofing C/N₀ values.

The upper limit of a GNSS signal power level is known a priori. Therefore, for a given receiver, an upper limit for the C/N₀ value can be defined. The spoofing detection metric based on C/N₀ monitoring works based on this fact. An abnormally high C/N₀ value can be an indication of a spoofing attack. In addition, jamming signals also affect the effective C/N₀ values by increasing the noise floor. A constructive multipath signal can cause a C/N₀ value to exceed the spoofing detection threshold and result in a false alarm. Illustratively, this metric may be used in conjunction with other spoofing detection metrics to reduce the false alarm probability. C/N₀ measurements along with the total input power can be used as an input to a neural network for spoofing detection.

A second exemplary metric is Signal Quality Monitoring (SQM). The interaction between authentic and spoofing signals causes distortion of the shape of the correlation function in the case of overlapped attack. Exemplary SQM tests focus on this feature in order to detect any asymmetry and/or abnormally sharp or elevated correlation peaks due to the presence of undesired signals. This metric was originally designed to monitor the correlation peak quality affected by multipath signals and has been widely used in the monitoring of signal quality in applications that require high integrity. One of the advantages of SQM tests is that they are not highly dependent on either a training or calibration process based on clean data. As mentioned previously, SQM metrics are designed to monitor correlation peak distortions due to multipath or overlapped spoofing attack. As such, they may exhibit high false-alarm rates under multipath conditions. Moreover, in the case of covered or non-overlapped spoofing attacks these metrics are not effective.

A third exemplary metric is clock monitoring. This metric focuses on detecting the presence of spoofing signals initiated from a single-antenna source based on the position level observables of a moving receiver. In a single antenna spoofing scenario, all fake PRNs are transmitted from the same antenna and therefore they all experience a common delay that is due to the propagation distance between spoofer antenna and the target receiver's antenna.

Another exemplary metric is the number of correlation peaks above the cross-ambiguity function (CAF). Considering GNSS signal properties, in an authentic scenario there should be only one detectable signal. A non-overlapped spoofing will generate signals located at a different code phase and/or frequency. One of the most effective ways to detect a spoofing attack is to monitor the CAF. This is similar to performing GNSS signal acquisition: a search for all the possible code phases and carrier Doppler values and estimating the number of correlation peaks above a given threshold.

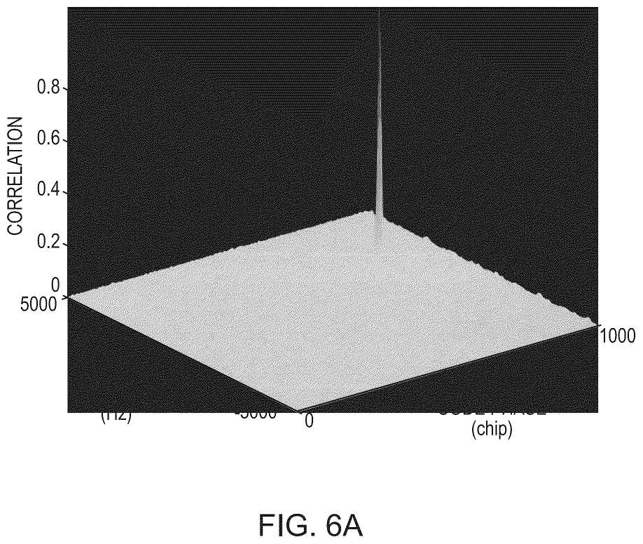

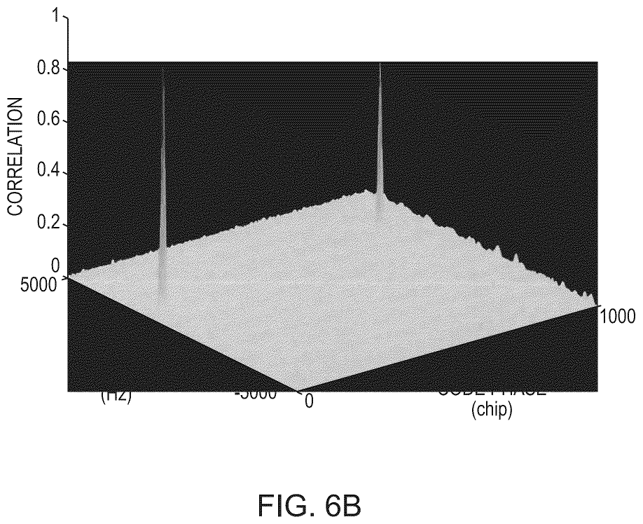

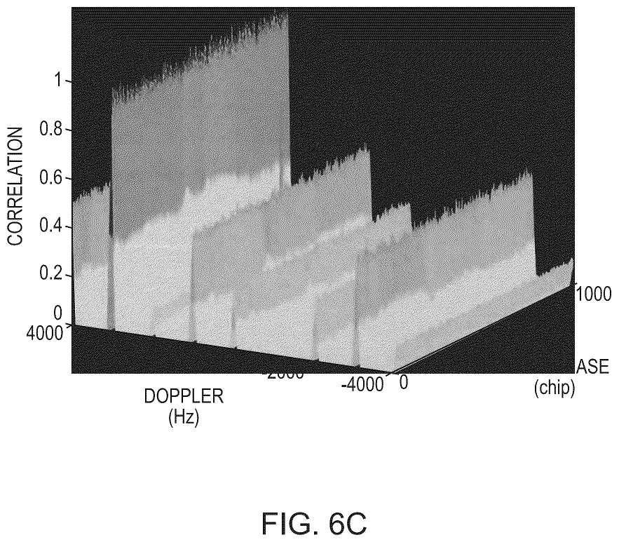

FIG. 6A shows the CAF for an authentic signal with only one distinguished peak. FIG. 6B shows the CAF for an environment that has both an authentic and a spoofing signal. FIG. 6C shows the CAF of an authentic signal that is being affected by a CW jammer. In a conventional approach, a spoofer detector should detect more than one correlation peak above the noise level. However, as shown in FIG. 6C, when the receiver is affected by a multi-tone CW jammer there are multiple peaks above the threshold and therefore false spoofing detection might occur.

The below Table 1 illustrates the described GNSS signal metrics and which type of attacks they may be used to detect.

TABLE 1
Spoofing Detection Metrics

| Detection Metric | Description | Targeted Attack |
|---|---|---|
| PSD plot | Measure of signal power in | High power spoofer |
| | frequency domain | |
| Input power | Total input power per encoder | High power spoofer |
| C/N₀ | C/N₀ measurements | High power spoofer |
| SQM | Code and carrier quality | Overlapped attack |
| | monitoring metrics | |
| CAF plot | CAF using FFT acquisition | Matched power |
| | outputs | |
| Clock bias/rate | To check the clock bias and | Single antenna spoofer |
| | clock rate inconsistency. A | |
| | sudden jump in clock bias, | |
| | clock rate or in general | |
| | receiver time (forward or | |
| | backward) | |

These metrics (also called features) previously described can be used by one or more neural networks to perform spoofing attack detection and classification, as described further below.

In one illustrative embodiment, all the metrics (features) shown in Table 1 are used as inputs to a single neural network. Such an illustrative neural network will have a large number of input neurons (e.g., 21,616) as shown in Table 2 in the case of detecting spoofers for L1 C/A CAF.

TABLE 2
Number of Input Neurons Required

| Detection Metric | Number of Inputs |
|---|---|
| PSD plot | 128 (# of FFT points) |
| Input power | 1 |
| C/N₀ | 1 |
| SOM | 2 |
| CAF plot for L1 C/A | 1,023 code phases × 21 (doppler |
| | freq +/− 2500 Hz in 250 Hz bins) |
| Clock bias | 1 |
| TOTAL | 21,616 |

Noted advantages of using a large input neural network that uses all the input metrics (features) at the same time is that, not only can it take advantage of the metrics themselves, but it can also take advantage of any relationships between the metrics to perform detection and classification. Large input neural networks can potentially exploit these relationships for better performance over small input neural networks that process subsets of inputs in “isolation”.

Noted disadvantages of such large neural networks includes the challenge of training because of the larger number of parameters to optimize. Training time may also be longer for the same reasons. However, the total number of parameters can significantly be dominated by internal parameters such as the number of inner layers neurons so this larger number of input neurons (and the associated parameters) may, in the end, not significantly impact training and optimization.

It should be noted that in alternative embodiments of the present invention, additional non-GNSS metrics may be used as inputs to a neural network. As noted above, inertial information obtained from an IMU may be utilized as an additional input to the neural network. Therefore, the description of GNSS signal based metrics should be taken as exemplary only.

Illustratively, the number of output neurons correspond to the number of classes to classify: {‘No Spoofer’, ‘High Power Spoofer’, ‘Overlapped Attack’, ‘Matched Power’, etc.}. The inner layers of such neural network can be a regular multilayer perceptron (MLP), convolutional neural network (CNN), recurrent neural network (RNN), and/or transformer neural network which can use the self-attention mechanism to either exploit the temporal relationship of input neurons or allow ‘communication’ between the different inputs (for a given epoch) to improve detection performance.

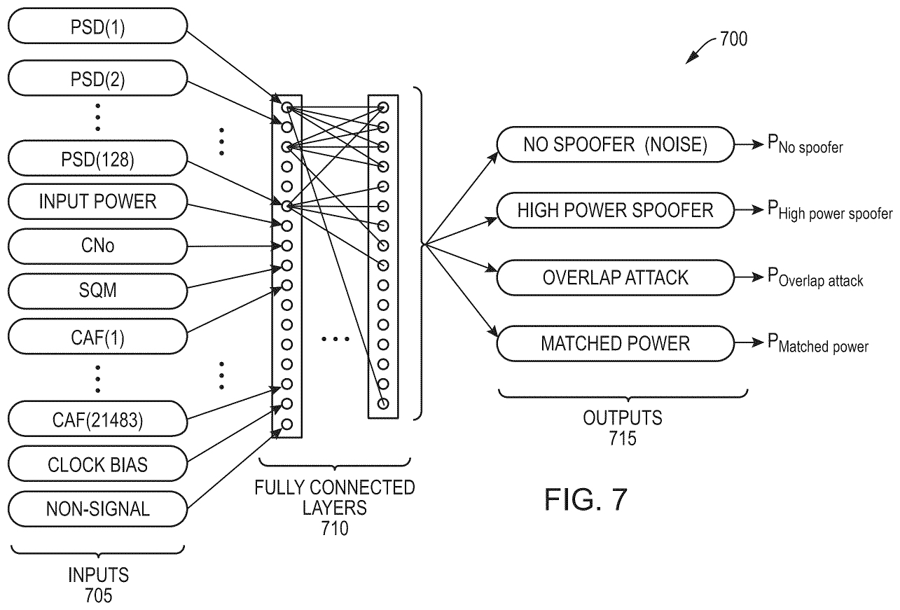

FIG. 7 is a schematic diagram of an exemplary neural network 700 for spoofing detection in accordance with an illustrative embodiment of the invention. A plurality of inputs 705, each of which is associated with one or more data points from a metric (GNSS signal based or non-GNSS signal based) are provided to a set of one or more fully connected layers 710 of a neural network.

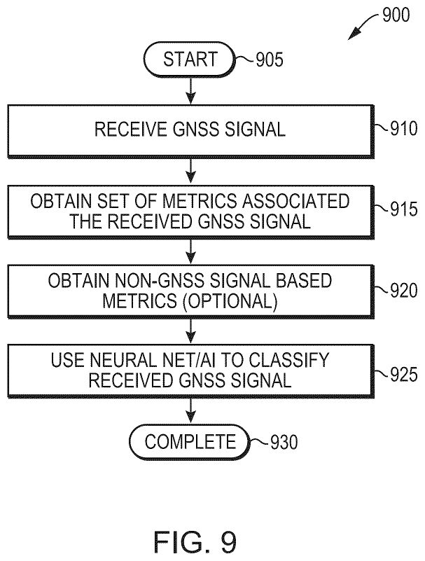

The output 715 of the connected layers allows determination of the class associated to the environment: ‘No spoofer’, ‘High Power Spoofer, etc. based on the output ‘P’ with the highest value. Operation of exemplary neural network environment 700 is described below in reference to the flowchart of procedure 900 in FIG. 9.

Another approach is to use specialized neural networks tuned to each of the metrics (features) and then combine output neurons of these specialized neural networks to make a final detection. This final detection may be performed by (1) one final neural network that processes the outputs of the specialized neural networks; (2) a rule-based algorithm that processes the outputs of the specialized neural networks; or (3) a combination of both approaches above.

The advantage of using specialized neural networks is that each only uses one or a small number of metrics (features) for targeted attack spoofer detection which makes their design and hyperparameter optimization easier as they tend to be smaller and simpler compared to the single neural network approach.

The final spoofer detection circuit can be a simple neural network that processes the outputs of all the specialized neural networks. This approach has the potential of making such a final (also referred to as second-level) neural network easier to design and optimize. Note that this final neural network can still be any of the types of neural network described above, e.g., MLP, CNN, RNN or transformers, but would be smaller (i.e. less neurons or less layers) as it would leverage the performance of the smaller lower-level networks.

It is also possible to use a rule-based algorithm to process the outputs of the specialized neural networks. In this approach, neural networks are used to perform what rule-based algorithms are poor at discerning but use a final rule-based algorithm that utilizes the outputs of these specialized networks to make the final detection decision. This can be accomplished because the specialized neural network's outputs can be made somewhat binary e.g., spoofer versus no spoofer (or can be made into simple fuzzy logic ‘spoofer’, ‘no spoofer’, or ‘not sure’ type states) which makes it easier to use a rule-based algorithm for the final detection decision. Thus, the detection decision is easier to explain as it is made with a rule-based algorithm on the specialized neural network binary ‘spoofer vs no spoofer’ outputs. Such a system incorporating the ability to explain a decision overcomes the known limitation of neural networks where it is, in general, not possible to explain how a decision is made because there could be thousands of parameters (e.g., weights and biases) that contribute to a decision. This explainability could also be useful in offline analysis of the overall detection performance and key to improving performance as one knows why a detection (or false detection) has not been carried out correctly.

Finally, it is possible to have the final decision jointly made by a neural network and a rule-based algorithm. One such approach is to have a neural network produce a final detection decision that is vetted by a rule-based algorithm to add redundancy to the final decision. This approach would arguably be more reliable as the final decision is made based on two independent methods (neural network based and rule-based) and would also be explainable. If the rule-based algorithm and the final neural network disagree, then a fail-safe decision (‘Uncertain Spoofer’) can be given to the user. Further, the ‘No Spoofer’ decision can also be more reliable which will have the benefit of more uptime for the system.

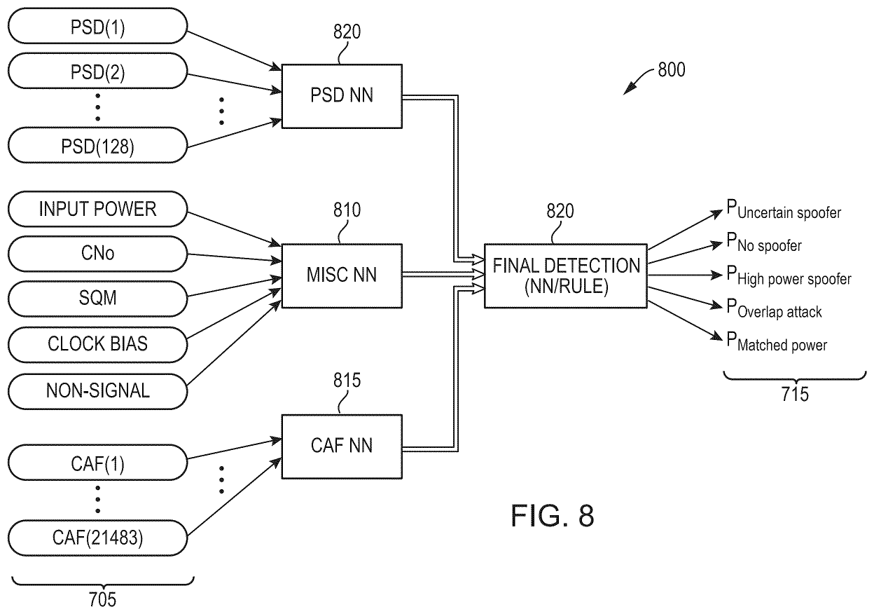

FIG. 8 illustrates a two-stage decision environment 800 that utilized the use of specialized neural networks and the final detection block in accordance with an illustrative embodiment of the present invention. In this example, the PSD inputs are fed in a PSD neural network (NN) 805 which is tuned to detect a ‘High Power’ spoofer. The CAF NN 815 is tuned to detect a ‘Match Power’ spoofer, and finally a Misc NN 810 is fed the remaining metrics i.e., Input Power, C/N₀, SQM, Clock Bias, and optional non-GNSS signal metrics to detect the remaining categories of spoofer as described above in Table 1. Note that the arrows between the specialized neural networks and the ‘Final Detection’ block are double lined to indicate that the specialized neural networks' outputs can be vectors and not a single number. The ‘PUncertain spoofer’ can be the fail-safe output of the Final Detection block 820 where the neural network and the rule-based algorithms disagree.

FIG. 9 is a flowchart detailing the steps of procedure 900 for using a neural network for spoofing detection in accordance with an illustrative embodiment of the invention. Exemplary procedure 900 corresponds to the embodiment shown and described above in relation to FIG. 7. Procedure 900 begins in step 905 and continues to step 910 where a GNSS signal is received at, e.g., antenna 210. The system then obtains a set of metrics associated with the received GNSS signal in step 915. As noted above, these metrics may comprise, inter alia, the PSD of the received signal, input power level, C/N₀, cross-ambiguity function (CAF) results, etc.

In optional step 920, non-GNSS signal based metrics are obtained. As noted above, these non-GNSS signal metrics may be, e.g., velocity data from an IMU, input from a vision system, etc. It should be noted that while steps 910 and 915 are shown in a particular order, in alternative embodiments, they may be performed in any order, or even in parallel. Therefore, the description of step 910 occurring prior to step 915 should be taken as exemplary only.

Then, in step 925, a neural network (or other AI system) is utilized to classify the received GNSS signal. As noted above in reference to FIG. 7, various decisions may be made including, e.g., that there is no spoofer, that there is a high-power spoofer, that there is an overlap attack, and/or that there is a matched power spoofer. Note that this list of possible decisions is not exhaustive and should be taken as exemplary only.

The procedure then completes in step 930. As will be appreciated by those skilled in the art, the decision made by procedure 900 may then be fed into a suitable remediation technique to counter any detected spoofer. Such remediation techniques may vary based on the type and intensity of the spoofing signal that was detected.

FIG. 10 is a flowchart detailing the steps of procedure 1000 for using a two-stage system for spoofing detection in accordance with an illustrative embodiment of the invention. Procedure 1000 is based on an exemplary embodiment shown and described above in relation to FIG. 8. Procedure 1000 begins in step 1005 and then continues to step 910 where a GNSS signal is received. Similar to procedure 900, step 915 and optional step 920 are then performed. Then, in step 1010, a set of neural networks are used to create one or more intermediate classifications.

The intermediate classifications are then fed into a final classifier, which may comprise of a rules-based system, a further neural network, or a combination thereof in step 1015. The procedure then completes in step 1020. As noted above, the determination of whether a signal is being spoofed or not, and the type of spoofing occurring, may be passed to another module/system for appropriate remediation techniques to be performed.

It should be noted that the various examples contained herein are to be taken as exemplary only. All operations described herein may be implemented in hardware, software, firmware, or a combination thereof. Therefore, the description of any particular functionality being implemented in any format should be taken as exemplary only. Further, the specific depictions of any particular NS format, such as GNSS, and/or frequency should be taken as exemplary only.

What is claimed is:

1. A computer implemented method for detecting spoofing of a navigation system (NS) signal, the method comprising the steps of:
receiving the NS signal;
obtaining a set of metrics associated with the received NS signal; and
using the set of metrics as input to a neural network to classify whether the received NS signal is affected by spoofing.

2. The computer implemented method of claim 1 wherein the set of metrics comprises power spectral density.

3. The computer implemented method of claim 1 wherein the set of metrics comprises total input power.

4. The computer implemented method of claim 1 wherein the set of metrics comprises carrier to noise ratio of the received NS signal.

5. The computer implemented method of claim 1 wherein the set of metrics comprises signal quality monitoring of the received NS signal.

6. The computer implemented method of claim 1 wherein the set of metrics comprises a clock bias of the received NS signal.

7. The computer implemented method of claim 1 wherein the set of metrics comprises a cross-ambiguity function of the received NS signal.

8. The computer implemented method of claim 1 wherein classifying whether the received NS signal is affected by spoofing further comprises determining a type of spoofing attack occurring.

9. The computer implemented method of claim 1 further comprising:
obtaining a set of non-NS signal metrics; and
using the set of non-NS signal metrics as additional inputs to the neural network.

10. The computer implemented method of claim 9, wherein the set of non-NS signal metrics comprises metrics from an inertial navigation system.

11. The computer implemented method of claim 1 wherein the NS signal comprises a global navigation satellite system (GNSS) signal.

12. A computer implemented method for detecting spoofing of a navigation system (NS) signal, the method comprising the steps:
receiving the NS signal;
obtaining a set of metrics associated with the received NS signal; and
dividing the set of metrics into one or more subsets;
using each of the one or more subsets of metrics as inputs to one or more neural networks to generate one or more intermediate outputs; and
providing the one or more intermediate outputs to a final decision module to classify whether the received NS signal is affected by spoofing.

13. The computer implemented method of claim 12 wherein the final decision module comprises a final decision neural network.

14. The computer implemented method of claim 12 wherein the final decision module comprises a rules-based system.

15. The computer implemented method of claim 12 wherein the final decision module comprises a final decision neural network and a rules-based system.

16. The computer implemented method of claim 15 further comprising classifying the received NS signal as uncertain spoofing when there is disagreement between the final decision neural network and the rules-based system.

17. A navigation system (NS) receiver, comprising:
an antenna configured to receive a NS signal;
a module configured to obtain a set of metrics associated with the received NS signal; and
a neural network configured to use the set of metrics as inputs and further configured to classify whether the received NS signal is affected by spoofing.

18. The NS receiver of claim 17 wherein the set of metrics comprises power spectral density.

19. The NS receiver of claim 17 wherein the set of metrics comprises total input power.

20. The NS receiver of claim 17 wherein the set of metrics comprises carrier to noise ratio of the received NS signal.

21. The NS receiver of claim 17 wherein the set of metrics comprises signal quality monitoring of the received NS signal.

22. The NS receiver of claim 17 wherein the set of metrics comprises a clock bias of the received NS signal.

23. The NS receiver of claim 17 wherein the set of metrics comprises a cross-ambiguity function of the received NS signal.

24. The NS receiver of claim 17 wherein classifying whether the received NS signal is affected by spoofing further comprises determining a type of spoofing attack occurring.

25. The NS receiver of claim 17 further comprising:
a module configured to obtain a set of non-NS signal metrics; and
wherein the neural network is further configured to use the set of non-NS metrics as additional inputs.

26. The NS receiver of claim 25, wherein the set of non-NS signal metrics comprises from an inertial navigation system.

27. The NS receiver of claim 17 wherein the NS signal comprises a global navigation satellite system (GNSS) signal.

28. A navigation system (NS) receiver comprising:
an antenna configured to receive a NS signal;
a module configured to obtain a set of metrics associated with the received NS signal and further configured to divide the set of metrics into one or more subsets;
one or more neural networks, each neural network configured to use one of the one or more subsets of metrics as inputs to generate one or more intermediate outputs; and
a final decision module configured to use the one or more intermediate outputs to classify whether the received NS signal is affected by spoofing.

29. The NS system of claim 28 wherein the final decision module comprises a final decision neural network.

30. The NS receiver of claim 28 wherein the final decision module comprises a rules-based system.

31. The NS receiver of claim 28 wherein the final decision module comprises a final decision neural network and a rules-based system.

32. The NS receiver of claim 31 wherein the final decision module classifies the received NS signal as uncertain spoofing when there is disagreement between the final decision neural network and the rules-based system.
